(19) United States
(12) Patent Application Publication
(10) Pub. No.: US 2019/0182942 A1
(43) Pub. Date: Jun. 13, 2019

(54) POWERING A LIGHT SWITCH

(71) Applicant: SIGNIFY HOLDING B.V., EINDHOVEN (NL)

(72) Inventors: Antonie Leonardus Johannes KAMP, EINDHOVEN (NL); Paul Theodorus Jacobus BOONEN, EINDHOVEN (NL)

(21) Appl. No.: 16/323,169

(22) PCT Filed: Jul. 24, 2017
(86) PCT No.: PCT/EP2017/068568

§ 371 Date: Feb. 4, 2019

(30) Foreign Application Priority Data
Aug. 5, 2016 (EP) 16182913.0

(51) Int. Cl. H05B 37/02; H05B 33/08

(52) U.S. Cl. CPC H05B 37/0272; H05B 33/0857

(57) ABSTRACT

A two-wire lighting system comprising a lighting device connected to a first wire, and a light switch connected to a second wire, and a connecting wire connecting the light switch to the lighting device. The first and second wires are connected across a mains system. The lighting device comprises a lighting controller and a bleeder controllable by the lighting controller. The light switch comprises a wireless transmitter, a switch controller and a mechanical switch connected to the switch controller. The switch controller is configured, in response to actuation of the mechanical switch by a user, to generate a bleeder activation signal in the connecting wire. The lighting controller is configured to activate the bleeder according to the bleeder activation signal so as to induce an operational current in the wires. The switch controller is configured to use the operational current to transmit a message from the wireless transmitter.

### TECHNICAL FIELD

The present invention relates to what is referred to herein as a “smart” light switch; that is, a light switch comprising a wireless transmitter that allows it to communicate with a lighting network based on wireless networking technology. The present invention relates in particular to a means of powering a smart light switch within a two-wire lighting system.

### BACKGROUND

A legacy, mains-powered lighting system may comprise at least one lighting device (e.g. luminaire) and at least one legacy light switch installed at a switch point of the lighting system, typically a wall switch. The light switch and the luminaire are connected to each other and to a mains voltage supply by electrical wires, and the light switch controls the luminaire by regulating an amount of electrical power drawn from the mains voltage supply. For example, a simple on/off switch switches the luminaire on and off, by connecting and disconnecting it from the mains supply respectively. A dimmer switch can be used to vary the (average) amount of current draw by the luminaire from the mains system, for example based on phase cut-dimming.

It is common for a legacy mains-powered lighting system to have its own dedicated electrical wiring that is separate from any wiring that powers generic power outlets, such as standard electrical power sockets. When a new building is constructed, the electrical wiring is typically laid relatively early on, before the internal walls are plastered and the floors laid, during a first phase of the construction referred to variously as “the first fix” or “roughing in”. Switch points (i.e. locations on the internal walls intended for wall switches), lighting points (i.e. locations on the internal ceilings, walls or even floors from to which the luminaires will connect), and the relationships between the switch points and the lighting points generally need to be chosen and the wiring laid accordingly.

According to various global regulatory requirements, the light switch is connected to an AC mains voltage supply by a so-called phase wire (referred to as a “live” or “hot” wire in some contexts), the lighting device is connected to ground (not to be confused with protective earth) by a so-called neutral wire, and a “switched-phase” wire (also referred to as a “switched-live” or “switched-hot” wire in some contexts) connects the light switch to the lighting device, the terminology reflecting the fact that this wire is only live when the switch is closed. As such, each switch point has at least two available connections: one to the phase wire, and the other to the phase-switched wire.

Notwithstanding these global regulatory requirements, it is technically possible to wire the lighting system the other way round, i.e. with the switch connected to ground and the lighting device connected to neutral. That is, with the phase and neutral wires effectively swapped. In this reverse configuration whether or not the wire connecting the lighting point to the switch point is hot depends on the connections at the lighting point rather than the switch point.

In a so-called “three-wire” lighting system, the wires are laid such that a third connection is also available at the switch point, namely a direct connection to the neutral wire and hence to ground. This is illustrated in FIG. 1A, which shows a switch point 102 and lighting point 104 in a three-wire installation. The phase wire, neutral wire and switch-phase wire are labelled P, N and SP respectively, and the mains voltage supply is labelled 106. This third connection point allows a device installed at the switch point 102 to draw current from the mains 106 independently of any device installed at the lighting point 104.

By contrast, in a so-called “two-wire” lighting system—an example of which is illustrated in FIG. 1B—the switch point 112 lacks this third connection point to the neutral wire N, hence its only path to ground is via the lighting point 104. Accordingly, any device installed at the switch point 112 can only draw current from the mains 106 if a device at the lighting point 104 is providing a closed connection between the switched-phase wire SP and the neutral wire N. Two-wire lighting systems are more common than three-wire systems in many countries, and particularly in older buildings.

Note FIGS. 1A and 1B are highly schematic circuit diagrams, representing the electrical topology of simplified example lighting systems. Real lighting systems may have more complex topologies, with multiple switch points and/or multiple lighting points. Note also: the term “wire” refers generally to a wired connection, such as a length of wire or multiple lengths of wire connected at, say, junction boxes or other connection nodes etc.

With the wiring laid, “the second fix” or “finishing” as it is variously known can be completed, in which plaster is applied and flooring laid. Among other things, this hides the electrical wiring. Whist it is possible to re-wire the system after this, this can be a highly disruptive and expensive process, and would normally only be undertaken as part of an extensive renovation, for example.

### SUMMARY

In contrast to legacy light switches of the kind described above, so called smart light switches are able to exert control over one or more smart lighting devices (e.g. smart lamps) using wireless networking technology, such as ZigBee, Wi-Fi, Bluetooth etc. That is, the smart lamp and the smart switch form a lighting network, and the smart switch transmits messages wirelessly within this network in order to control one or more characteristics of light emitted by one or more smart lamps to which it is bound. The messages can be sent directly to the lighting device, or they may be relayed via one or more other devices, such as another lighting device in the lighting network, a gateway (e.g. bridge), or a wireless router (for example).

A basic smart switch may mirror the operation of a conventional light switch closely to provide basic control functionality (e.g. on/off, or possibly dimming). However, its role within the lighting network can be reconfigured easily to change which lighting device(s) it is bound to (i.e. which lighting device(s) it controls). This is a straightforward process, in which one or more settings of the light switch and/or smart lamps are adjusted, for example using a user-friendly application (app) executed on a user device (e.g. smartphone), or an interface mechanism of the device(s) themselves. By contrast, an equivalent reconfiguration of a legacy system would be a far more complex task, requiring extensive re-wiring. Thus smart switches are able to provide significantly more flexibility than legacy mains switches with comparable day-to-day functionality.

As well as being more convenient for a user, smart lighting systems may require smart switches for compatibility reasons: in particular, as smart lamps that are not emitting may need to be able to receive a wireless instruction to begin emitting when the user chooses, which may not be possible if power to the lamp has been cut off from the mains with a legacy switch. That is, even non-emitting smart lamps may need some power.

Retrofit smart switches which replace legacy wall switches at the same switch points are an attractive option because the switch points are often at well-chosen locations. Moreover, the retrofit smart switch can make sure the smart light is always powered to be able to interact with the system (even when non-emitting), as it can be configured to provide a constant connection between the neutral and phase-switch connection points at that switch point.

However, a problem arises, namely that of powering the smart switch, as a smart switch has quite different power requirements to legacy switches.

One option would be to use a battery, but this is inconvenient for the user as replacing the battery is burdensome for the user. Another option would be to use energy harvesting but this has various drawbacks, such as price, haptic feedback, and energy budget limiting its functionality.

A third solution is using the mains power which is available at the legacy switch location. However, as noted above, in a two-wire lighting system, the neutral wire N is not available. Therefore, a smart switch is unable to draw current independently at a two-way switch point, and therefore requires a special two-wire power supply in combination with a so-called “bleeder” in the smart lamp to which it is electrically connected (via the switched-phase wire SP) in order to actually draw enough current for wireless operations.

With reference to FIG. 1B, the bleeder is electrical circuitry in the lamp which provides a persistent electrical connection between the switched-phase wire SP and the neutral wire N at the lighting point 104, so as to allow an operational current to be drawn from the mains via the bleeder. The operational current has a sufficiently high magnitude to allow a smart switch installed at switch point 112 to transmit a wireless message via its wireless transmitter. An example of a lamp which includes a bleeder circuit for use in a two-wire system is disclosed in PCT Patent Publication WO2016062574. However, its simplest form, a bleeder can simply be a load having a suitable electrical resistance between SP and N, which draws a continuous current in accordance with Ohm's law.

Whilst effective, this solution of a two-wire smart switch in combination with a bleeder has the downside that the power supply has constant standby power losses, even though the switch often only needs a relatively high amount of electrical power intermittently (e.g. in order to send a wireless message). That is, the supply for the smart switch would have inherent power losses even if the switch is not being used.

In light of ever stricter regulations on standby power consumption, is envisaged that future regulatory requirements may even prohibit such high standby losses for such a simple switch.

The present invention does adopt this third solution of the bleeder, but makes use of a selectively activated bleeder in the smart lamp to solve the problem of standby power consumption. By only activating the bleeder when the switch is used, excessive standby power losses are prevented.

A mechanical user-operable switch in the smart switch, when actuated by a user, powers-up an otherwise fully deactivated two-wire power supply system, by activating the bleeder. The bleeder is activated by a bleeder activation signal generated by the smart switch in the switched-phase wire itself for detection by the smart lamp.

A first aspect of the present invention is directed to a two-wire lighting system comprising a lighting device (“smart lamp”) connected to a first wire, a light switch (“smart switch”) connected to a second wire, and a connecting wire connecting the light switch to the lighting device. The lighting device comprises a lighting controller and a bleeder controllable by the lighting controller. The first and second wires are connected across a mains system. The light switch comprises a wireless transmitter, a switch controller and a mechanical switch connected to the switch controller. The switch controller is configured, in response to actuation of the mechanical switch by a user, to generate a bleeder activation signal in the connecting wire. The lighting controller is configured to activate the bleeder according to the bleeder activation signal so as to induce an operational current in the wires. The switch controller is configured to use the operational current to transmit a message from the wireless transmitter.

Preferably the first wire is a neutral wire, the second wire is a phase wire to conform to global regulatory requirements. In this context, the connecting wire is called the switched-phase wire, as noted.

There are various ways in which sufficient power can be supplied to the switch controller to allow it to generate this initial bleeder activation signal. This is because significantly less power is needed to generate the bleeder activation signal than is needed to transmit the wireless message.

For example, the switch controller may be configured to use a leakage current induced in the wires by the lighting device when the bleeder is inactive to generate the bleeder activation signal, where the leakage current has a lower magnitude than the operational current.

As another example, the actuation of the switch may cause a dropout of a mains voltage supplied to the lighting device via the connecting wire, and the lighting controller may be configured to activate the bleeder in response to the mains dropout so as to induce an initial current in the wires. The switch controller may be configured to use the initial current to generate the bleeder activation signal to keep the bleeder active. In other words, the mains drop out caused by actuating the mechanical switch activates the bleeder, and the bleeder activation signal keeps it activated.

The mechanical switch may be connected in parallel with the switch controller, and the actuation of the mechanical switch may open it so as to provide the leakage current or the initial current to the switch controller.

Preferably, the bleeder activation signal is a phase cut in a mains voltage supplied to the lighting device via the connecting wire.

The light switch may further comprise a control switch connected in series with the mechanical switch, which is controllable by the switch controller.

For example, the switch controller may be configured to use the control switch to create the phase cut.

The light switch may comprise a second control switch connected in parallel with the switch controller and the series-connected switches. The switch controller may be configured to use the second control switch to create the phase cut, and to open the control switch to receive the operational current.

An advantage of using this additional and parallel-connected second switch to create the phase cut is that is provides additional robustness, in the event that the user actuates the mechanical switch again before the switch controller has completed its processing. This is because a second actuation of the mechanical switch has no effect for as long as the control switch connected in series with it is being kept open to receive the operational current.

The lighting controller may be configured to control at least one light emitting device of the lighting device in response to the wirelessly transmitted message.

For example, the lighting controller may be configured change a luminous intensity and/or a chromaticity of light emitted by the at least one light emitting device in response to the wirelessly transmitted message.

Alternatively, the lighting controller may be configured to activate or deactivate the at least one light emitting device in response to the wirelessly transmitted message.

Alternatively or in addition, the lighting system may comprise a second lighting device configured to respond to the message, e.g. in an equivalent manner.

Each of the controllers can for example comprise one or more microcontrollers, configured to carry out the recited operations. For example, the operations may be implemented by code executed on a microprocessor of that microcontroller. Alternatively, at least part of this functionality can be implemented by dedicated circuitry of the relevant controller.

A second aspect of the present invention is directed to a light switch for use in a two-wire lighting system, the light switch comprising: a first connection for connecting to a phase or neutral wire; a second connection for connecting to a lighting device via a connecting wire; a switch controller; a mechanical switch connected to the switch controller; and a wireless transmitter; wherein the switch controller is configured, in response to actuation of the mechanical switch by a user, to generate a bleeder activation signal in the connecting wire, and to use a resulting operational current induced in the wires by a bleeder of the lighting device to transmit a message from the wireless transmitter.

Preferably, the first connection is a phase connection for connecting to the phase wire, and the second connection is a switched-phase connection (where the connecting wire is a switched-phase wire).

A third aspect of the present invention is directed to a method of controlling a light switch for use in a two-wire lighting system, the method comprising implementing by a switch controller of the light switch the following steps: in response to actuation by a user of a mechanical switch of the light switch, generating a bleeder activation signal in a connecting wire connected to the light switch and a lighting device; and using a resulting operational current induced by a bleeder of the lighting device in the connecting wire and a phase or neutral wire connected to the light switch to transmit a message from a wireless transmitter of the light switch.

In embodiments of the second or third aspect, any of the functionality disclosed in relation to the first aspect can be implemented.

Another aspect of the present invention is directed to a computer program product comprising code stored on a computer readable storage medium (e.g. magnetic, optical or solid-state storage, or any combination thereof) and configured when executed on a switch controller of a light switch to implement any of the disclosed functionality.

### BRIEF DESCRIPTION OF FIGURES

For a better understanding of the present invention, and to show how embodiments of the same may be carried into effect, reference is made by way of example to the following figures in which:

FIG. 1A shows a schematic circuit diagram demonstrating certain principles of a three-wire lighting system;

FIG. 1B shows a schematic circuit diagram demonstrating certain principles of a two-wire lighting system;

FIG. 2 shows a highly schematic block diagram of a two-wire lighting system comprising a first example smart switch;

FIG. 3 shows a highly schematic block diagram of a second example smart switch.

### DETAILED DESCRIPTION OF EXAMPLE EMBODIMENTS

Examples of a two-wire retrofit smart switch (2a, 2b) are described below, which operate in combination with a smart bleeder with negligible standby power losses. This is achieved by having a special two-wire power supply unit in the smart switch and the bleeder disabled by default. When (and only when) the user presses a mechanical switch of the smart switch, the power supply unit of the smart switch is activated for a short time, which in turn activates a switch controller of the smart switch.

In this respect, the smart lamp may be configured to detect the pressing of the mechanical switch and activate its bleeder in response, which in turn provides the power needed to activate the power supply unit and switch controller of the smart switch. Alternatively, a small leakage current drawn by the smart lamp (e.g. via its EMI filter capacitors) may be sufficient to activate the supply unit and switch unit of the smart switch initially, without requiring activation of the bleeder at this point.

Either way, as soon as a microprocessor of the switch controller is powered, it takes over the control of its own power supply. The microprocessor can perform any required processing, e.g. to notify the lamp, another smart lamp or more generally the lighting system that the mechanical switch has been pressed by transmitting a suitable wireless message, but it can also perform more complex operations like downloading and installing a software update. When finished, it disables itself and the whole two-wire power supply system again to prevent the consumption of significant standby power. Note the smart lamp is still powered with mains voltage via the smart switch; but the two-wire power supply unit of the switch itself is unpowered to prevent it from incurring standby losses.

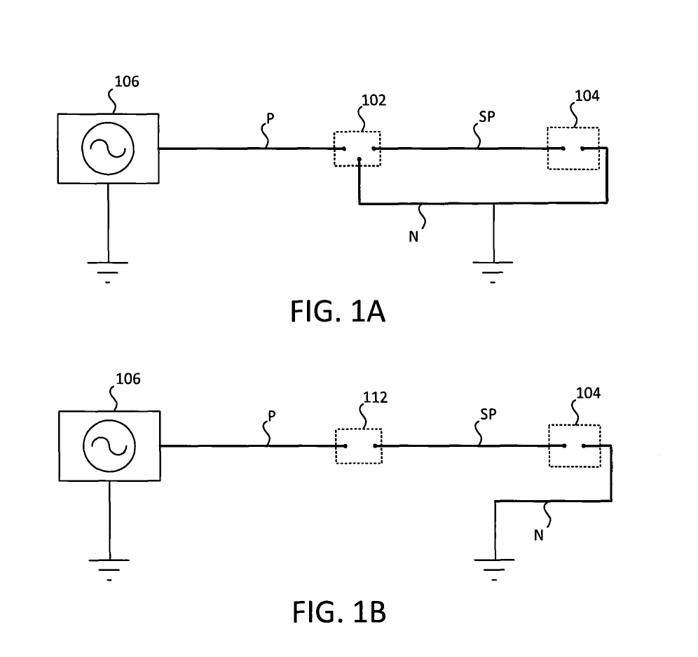

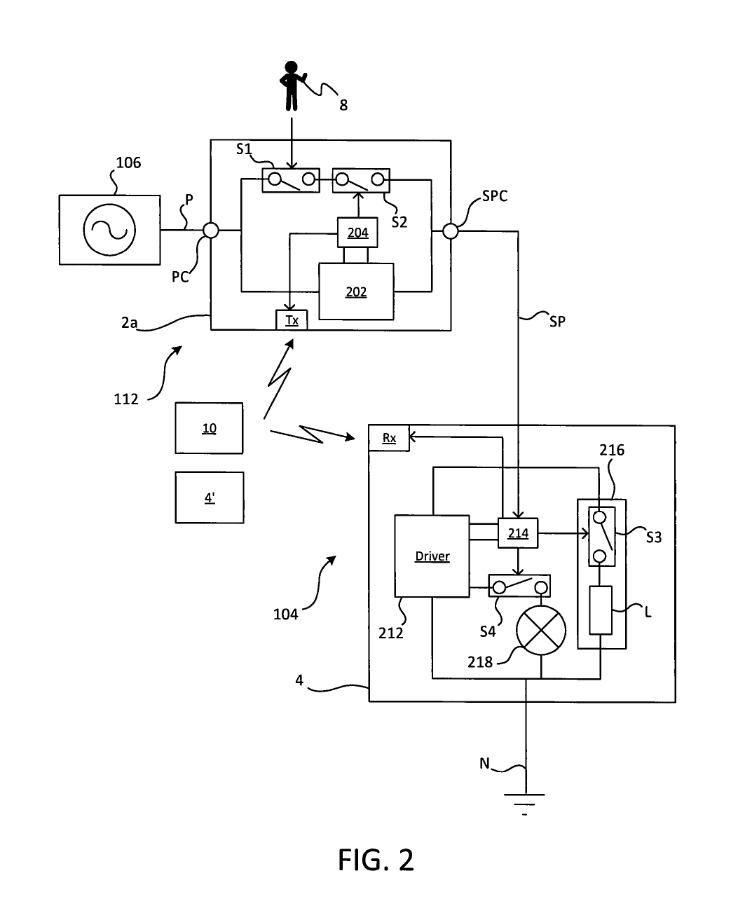

FIG. 2 shows a schematic block diagram of a two-wire lighting system, which comprises a smart switch 2a and a smart lamp 4. The smart switch 2a is installed at switch point 112 and the smart lamp 4 at lighting point 104 of FIG. 1B.

The smart switch 2a comprises a phase connection PC, a switched-phase connection SPC, a two-wire supply unit 202, a switch controller 204, a mechanical switch S1 (first switch), a control switch S2 (second switch), and a wireless RF (radio frequency) transmitter Tx connected to the switch controller 232. This transmitter Tx could for example be part of a wireless transceiver, so that the switch can both transmit and receive messages wirelessly (though this is not essential).

The phase connection PC is connected to the phase wire P, and thus connected to the mains voltage supply 106. The switched-phase connection SPC is connected to the switched-phase wire SP, to which the smart lamp 4 is also connected.

The switch controller 204 has two power connectors, each connected to a different power connector of the two-wire supply unit 202. The switch controller 204 is thus connected in series with the supply unit 202 for receiving electrical current provided by the supply unit 202. The supply unit is 202 is connected across the connectors PC and SPC, and is thus connected across the mains voltage (i.e. between the mains voltage supply 106 and ground) if and when the switched-phase wire SP is connected to ground. In this state, the supply unit 202 can thus supply electrical power to the switch controller 204 by drawing electrical current from the mains. The switch controller 204 regulates the amount of electrical power supplied to the switch controller 204, for example using current or voltage regulation. For example, using phase-cut voltage regulation.

As shown in FIG. 2A, the switch controller comprises a processor (microprocessor) 232 connected to the supply unit 202 and the wireless transmitter Tx, and a memory 234 connected to the processor 232. The memory 234 holds code 236 for execution on the processor 232. The processor 232 is configured so that, when it is first powered up (i.e. in response to an initial receipt of electrical current from the switch controller 204), it automatically fetches and executes a portion of the code 236, causing it to automatically perform certain operations defined by the portion of the code 236 and described in detail below. That is, such that these operations are performed automatically as soon as the processor 232 is powered up. For now, suffice it to say that these operations include generating a bleeder activation signal in the switched-phase wire SP.

The processor 232 and memory 234 are embodied in a microcontroller in this example.

Returning to FIG. 2, the first and second switches S1, S2 are connected in series with each other, across the switch connections PC, SPC and in parallel with the switch controller 204 and supply unit 202. The first switch S1 is operable by a user 8, i.e. it is a manually-operated switch, and is a mechanical switch in this example.

By contrast, the second switch S2 is controlled automatically by the switch controller 204. To this end, the switch controller 204 has a control output connected to a control input of the second switch S2. The second switch S2 can for example be a transistor, and the control input may be a gate terminal (for an FET) or a base terminal (for a bi-polar transistor). The switch controller 204 is thus able to open and close the second switch S2 automatically.

The first and second switches S1, S2 are both configured such that they are closed by default. That is, in the absence of actuation by the user 8, the first switch S1 remains closed; in the absence of any control signal at is control input (e.g. for a zero voltage at its control input, corresponding to logical zero), likewise the switch S2 remains closed. That is, the default state of the switch S1 and default unpowered state of the microprocessor control switch S2 is closed (which can be arranged by appropriate component selection and design of the electronic circuit).

Thus, in the default state with both switches S1, S2 closed, a zero-resistance path (i.e. short circuit) between the switch connections PC, SPC is formed. That is, having a negligible electrical resistance, which is significantly less than that of the supply unit 202 connected in parallel. Accordingly, in this default state—referred to as default standby mode—the voltage across the supply unit 202 is substantially zero (i.e. negligible), even when the switch-phase wire SP is connected to ground. As such, in default standby mode, the two-wire power supply unit 202 in the smart switch 2a is deactivated, irrespective of whether or not the switch-phase wire SP is currently grounded.

The switch controller 204 is also connected to the wireless transmitter Tx. It can thus control the wireless transmitter Tx to transmit a wireless message, carried by an RF signal, provided there is sufficient power available to do so. The transmitter Tx can also be powered by the supply unit 202, and in any event is ultimately powered by the mains 106. By way of the operations described below, the switch controller 204 cooperates with the smart lamp 4 to obtain the requisite power for the transmission when needed.

Turning to the smart lamp 4, this comprises a driver 212; a lighting controller 214 connected to the driver 212; a bleeder 216, which in turn comprises a control switch S3 (third switch) and a load L connected in series with switch S3; at least one light emitting device 218, which is preferably an LED(s); another control switch S4 (fourth switch); and a wireless receiver Rx. This receiver Rx could for example be part of a wireless transceiver, so that the lamp 4 can both transmit and receive messages wirelessly (though this is not essential).

The light emitting device 218 is connected to the driver 212 via switch S4 such that, when S4 is closed, the light source 218 can receive electrical power from the driver 212 causing it to emit light. The lighting controller 214 is also connected to and powered by the driver 212, and has a control output connected to a control input of switch S4 so that it can selectively open and close the switch S4, to cause the light emitting device 218 to start and stop emitting light respectively. The lighting controller 214 also comprises a microcontroller, which implements the functionality described below.

The lighting controller 214 is also connected to the wireless receiver Rx, so that it can receive messages transmitted wirelessly from another device.

The lighting controller 214 is also connected to the bleeder 216. In particular, the lighting controller 214 has a second control output connected to a control input of switch S3 of the bleeder 216, so that it can selectively open and close switch S3 to deactivate and activate the bleeder 216 respectively.

Switches S2, S3 can for example be transistors, implemented in a similar fashion to switch S1.

The driver 212 is connected between the switched-phase wire SP and the neutral wire N. The bleeder 216 is also connected in parallel between those same wires SP, N, i.e. in parallel with the driver 212.

The lamp 4 is configured such that the bleeder 216 is inactive by default (i.e. the switch S3 is open). The lighting controller 214 is also connected to the switched-phase wire SP, which enables it to detect the bleeder activation signal generated in the switched-phase wire SP by the smart switch 2a. The bleeder activation signal is generated by the switch controller 204 of the smart switch 2a, in order to activate the bleeder 216 when the switch controller 204 needs to perform an operation requiring a relatively high amount of electrical power, such as transmitting a wireless message.

The bleeder activation signal takes the form of a phase-cut in the AC mains voltage supplied via the switched-phase wire SP. The lightning controller 214 keeps the bleeder 216 active (i.e. the switch S3 closed) for as long as the phase cut is present.

Note that, even when the bleeder 216 deactivated (switch S3 open) and the LED 218 is not emitting (switch S4 open), the driver 212 of the smart lamp 4 still draws a small amount of current from the mains 106, for example by one or more EMI filters thereof, via switches S1 and S2 of the smart switch 2a (which, as noted, are closed by default). This current drawn by the smart lamp 4 is referred to as a leakage current. Returning to the smart switch 2a, when the user 8 presses (or otherwise actuates) switch S1, voltage starts to rise across the smart switch 2a, and across the two-wire supply unit 202 in particular causing it to activate. Opening switch S1 removes the zero-resistance path between connections PC, SPC, thereby providing the leakage current drawn by the smart lamp 4 to the supply unit 202. This charges the power supply unit 202, which in turn allows it to supply sufficient electrical power for the lighting controller 204 to be activated.

The mechanical switch S1 is designed such that it bounces back (or otherwise automatically closes) within a few hundred milliseconds, irrespective of whether the user is still pressing it. This allows the two-wire power supply 202 to start, but prevents the smart lamp 4 from being disconnected from the mains for so long that it starts to drop out. Drop out means that it is disconnected from the mains for so long that it starts to lose functionality. This short, few 100 ms disconnection from mains can be buffered in the smart lamp 4 straightforwardly, using conventional mechanisms, so that its functionality is not adversely affected.

Switch S1 may for example be a mechanical pushbutton switch which normally is only pressed shortly to activate the lights.

When the two-wire power supply 202 has charged for the first time, in some embodiments the microcontroller of the switch controller 204 will start-up, and in response it automatically creates a small phase cut in the mains voltage supplied to the lamp 4 via the switched-phase wire SP, using switch S2—thereby generating the bleeder activation signal mentioned above, in order to secure power supply generation for the smart switch 2a when the mechanical switch S1 has bounced back. A phase cut refers to a cutting of the mains voltage (to zero) for an interval directly before or directly after each zero-crossing of the mains voltage. However, powering-up the microcontroller is not essential at this stage. For example, the phase cut can be created by other circuitry of the lighting controller 204, which operates in parallel with the microcontroller.

This phase-cut is detected and recognized by the lighting controller 214 in the smart lamp 4, which actives the bleeder 216 in response. This causes the bleeder 216 to draw a current via load L (operational current), which in turn provides sufficient power for use by the microprocessor of the switch controller 204 during the phase-cut timeframe, i.e. for as long as the phase cut persists.

The microprocessor of the switch controller 204 can use the operational current to run any kind of program, or communicate with one or more (e.g. multiple) smart lamps 4, 4′ of the lighting system or a control node 10 of the lighting system (e.g. a bridge or wireless router) via the wireless transmitter Tx. It can do so for as long as it requires, as the switch controller 204 is now controlling its own power supply.

For example, the switch controller 204 may use the wireless transmitter Tx to transmit a message to the smart lamp 4. This can be transmitted directly to it for receiving with its wireless receiver Rx, or alternatively it can be relayed via the central control node 10, or via one or more other smart lamps 4′ of the lighting system (e.g. using ZigBee). However, it is important to note that there is nothing to limit this to wireless communication between the smart switch 2a and the smart lamp 4 to which it happens to be electrically connected. For example, the message could be transmitted to the central node 10 for processing thereat, or to a different smart lamp(s) 4′ to which the smart switch 2a is bound. In particular, there is no requirement that the switch controls the smart lamp to which it happens to be electrically connected, though in practice it may be convenient for it to do so.

A message can for example cause the smart lamp 4 and/or another smart lamp(s) 4′ to vary a characteristic of light emitted by its light emitting device(s) 218 (such as luminous intensity or chromaticity), or in a simpler case simply to activate or deactivate its light emitting device(s) 218.

Note that the central control node 10 is not essential. The switch can instead communicate directly with the lamp(s) 4/4′, for example using Bluetooth.

When the microprocessor of the switch controller 204 has completed those operations, whatever they may be, it deactivates the phase cut in order to cut off its power supply. This is recognized by the microprocessor in the lighting controller 214, which in turn disables the bleeder 216, thereby terminating the operational current to prevent excessive standby losses. That is, the switch controller 204 terminates the phase cut mechanism when its work is finished and starts the phase cut mechanism each time the opening of the first switch S1 is detected.

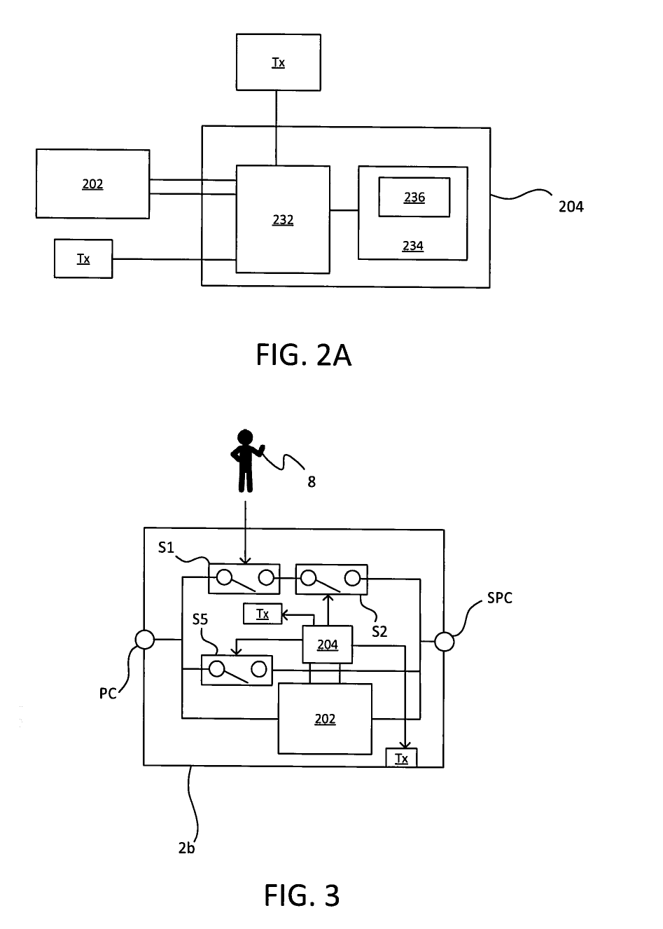

FIG. 3 shows another example of a smart switch 2b, which is largely the same as the smart switch 2a, but with certain differences that are set out below. The same reference signs are used in FIGS. 2/2A and 3 to denote corresponding features, and all description pertaining to those features in relation to the switch 2a of FIGS. 2/2A applies equally to the switch 2b of FIG. 3 and vice versa.

Smart switch 2b comprises an additional control switch S5 (fifth switch), which is also connected in parallel between switch connections PC and SPC, in parallel with switches S1 and S2, and in parallel with the supply unit 202. The switch S5 has a control input connected to a second control output of the switch controller 204, so that it can be controlled (opened and closed) by the switch controller 204 in the same manner. This fifth switch S5 is used to control the phase cut, instead of switch S2.

As with switch 2a, in default standby mode, the two-wire power supply 202 in smart switch 2b is deactivated. The default state of the mechanical switch S1 and default unpowered state of the switch S2 is closed as for smart switch 2a, however switch S5 used to control the phase cut is by default open (defined by design of the electronic circuit).

When the user 8 presses the switch S1, voltage starts to rise across the smart switch unit and the special two-wire power supply 202 will activate as described. When the two-wire power supply 202 has charged for the first time, the microcontroller of the switch controller 204 start-up and opens switch S2 such that the two-wire power supply will not be deactivated by the user releasing (i.e. closing) switch S1. That is, switch S2 is opened to prevent the closing of switch S1 from short circuiting the two-wire power supply.

Simultaneously with the opening of switch S2, the microprocessor of smart switch 2b creates a small phase cut in the same manner, but using switch S5, to secure power supply generation when the mechanical switch S1 has bounced back.

An additional benefit of switch S5, directly connected to PC and SPC, is that another actuation of switch S1 by the user 8 will not deactivate the process instigated by the earlier actuation. This is in contrast to the case of switch 2a, where the user 8 may, in some circumstances, be able to inadvertently interrupt the operation by pressing switch S1 again at some point in the communication. As such, the additional switch S5 improves the robustness of the smart switch 2b.

Thereafter the operation is exactly as described above, with the switch controller 204 closing switch S2 to cut off its power supply when completed.

It will be appreciated that the above embodiments have been described by way of example only. Other variations to the disclosed embodiments can be understood and effected by those skilled in the art in practicing the claimed invention, from a study of the drawings, the disclosure, and the appended claims.

For example, whilst in the above examples the respective functionality of the switch controller 204 and lighting controller 214 are implemented in software (by code executed on a respective microcontroller), some or all of this functionality could instead be implemented in dedicated hardware, for example by an application-specific integrated circuit or a suitably configured FPGA of the controller in question.

As another example, whilst in the above the mechanical switch S1 is a special mechanical switch, which is biased so as to automatically return to its initial state once actuated, alternatively this could also be a control switch controlled by the switch controller in response to inputs from the user. For example, the leakage current may be sufficient to allow this.

In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A two-wire lighting system comprising:
a lighting device connected to a first wire, the lighting device comprising a lighting controller and a bleeder controllable by the lighting controller;
a light switch connected to a second wire, the light switch comprising a wireless transmitter, a switch controller and a mechanical switch connected to the switch controller; and
a connecting wire connecting the light switch to the lighting device;
wherein the first and second wires are connected across a mains system;
wherein the switch controller is configured, in response to actuation of the mechanical switch by a user, to generate a bleeder activation signal in the connecting wire; and
wherein the lighting controller is configured to activate the bleeder according to the bleeder activation signal so as to induce an operational current in the wires, wherein the switch controller is configured to use the operational current to transmit a message from the wireless transmitter.

2. A two-wire lighting system according to claim 1, wherein the switch controller is configured to be powered by a leakage current induced in the wires by the lighting device when the bleeder is inactive to generate the bleeder activation signal, wherein the leakage current has a lower magnitude than the operational current.

3. A two-wire lighting system according to claim 1, wherein the actuation of the mechanical switch causes a dropout of a mains voltage supplied to the lighting device via the connecting wire, and the lighting controller is configured to activate the bleeder in response to the mains dropout so as to induce an initial current in the wires;
wherein the switch controller is configured to be powered by the initial current to generate the bleeder activation signal to keep the bleeder active.

4. A two-wire lighting system according to claim 1, wherein the bleeder activation signal is a phase cut in a mains voltage supplied to the lighting device via the connecting wire.

5. A two-wire lighting system according to claim 2, wherein the mechanical switch is connected in parallel with the switch controller, and the actuation of the mechanical switch opens it so as to provide the leakage current or the initial current to the switch controller.

6. A two-wire lighting system according claim 4, wherein the light switch further comprises a control switch connected in series with the mechanical switch, which is controllable by the switch controller.

7. A two-wire lighting system according to claim 6, wherein the switch controller is configured to use the control switch to create the phase cut.

8. A two-wire lighting system according to claim 6, wherein the light switch comprises a second control switch connected in parallel with the switch controller and the series-connected switches, wherein the switch controller is configured to use the second control switch to create the phase cut, and to open the control switch to receive the operational current.

9. A two-wire lighting system according to claim 1, wherein the lighting controller is configured to control at least one light emitting device of the lighting device in response to the wirelessly transmitted message.

10. A two-wire lighting system according to claim 9, wherein the lighting controller is configured change a luminous intensity and/or a chromaticity of light emitted by the at least one light emitting device in response to the wirelessly transmitted message.

11. A two-wire lighting system according to claim 9, wherein the lighting controller is configured to activate or deactivate the at least one light emitting device in response to the wirelessly transmitted message.

12. A light switch for use in a two-wire lighting system, the light switch comprising:
a first connection for connecting to a phase wire or a neutral wire;
a second connection for connecting to a lighting device via a connecting wire;
a switch controller;
a mechanical switch connected to the switch controller; and
a wireless transmitter;
wherein the switch controller is configured, in response to actuation of the mechanical switch by a user, to generate a bleeder activation signal in the connecting wire, and to use a resulting operational current induced in the wires by a bleeder of the lighting device to transmit a message from the wireless transmitter.

13. A method of controlling a light switch for use in a two-wire lighting system, the method comprising implementing by a switch controller of the light switch the following steps:
in response to actuation by a user of a mechanical switch of the light switch, generating a bleeder activation signal in a connecting wire connected to the light switch and a lighting device; and
using a resulting operational current induced by a bleeder of the lighting device in the connecting wire and a phase wire or a neutral wire connected to the light switch to transmit a message from a wireless transmitter of the light switch.

14. A method according to claim 13, wherein the bleeder activation signal is a phase cut in a mains voltage supplied to the lighting device via the connecting wire.

15. A computer program product stored on a computer readable storage medium and configured when executed on a switch controller of a light switch to implement the method of claim 14.
